(19) United States
(12) Patent Application Publication
(10) Pub. No.: US 2014/0071060 A1
(43) Pub. Date: Mar. 13, 2014

(54) PREVENTION OF ACCIDENTAL TRIGGERS OF BUTTON EVENTS

(71) Applicant: Lucinio Santos-Gomez, Durham, NC (US)

(72) Inventor: Lucinio Santos-Gomez, Durham, NC (US)

(73) Assignee: INTERNATIONAL BUSINESS MACHINES CORPORATION, Armonk, NY (US)

(21) Appl. No.: 13/610,391

(22) Filed: Sep. 11, 2012

(51) Int. Cl. G06F 3/041

(52) U.S. Cl. 345/173

(57) ABSTRACT

A method for preventing accidental trigger of an action in an electronic device, the method performed by program instructions executed on a computer having at least one processor, the method comprising: providing at least one affordance that is associated with a main action and is in a ready state; responsive to detecting a button event for the affordance, providing the affordance with progressive feedback related to a time the affordance is touched until the main action is invoked; and initiating the main action only after a predetermined touch hold time threshold is reached.

### BACKGROUND

In electronic devices, actions such as “Call” and “Send” are typically invoked in applications (e.g., voice and text) through standard buttons. One a user presses a button, the device detects the button press event and invokes the action associated with the button. Attempts have been made to limit accidental button presses and the triggering of actions.

For instance, long pressing is a technique in which a user must hold down a button in mobile devices to invoke secondary actions, like launching context menus (performing the role of a “right click” on a desktop device) or “hidden” functions (like showing a list of previously visited sites, or assigning voice control of the device). However, the main actions associated with buttons are still subject to accidental trigger of button events.

The Android™ operating system is designed to run on touchscreen-enabled devices. These devices use virtual keys such as HOME, MENU, BACK, and SEARCH, rather than physical keys. Android 2.0 attempts to improve the user experience on those devices by executing these buttons at key-up in a key-down/key-up pair, rather than key-down, to let user press the button area and then drag out of it without generating an event. However, even with this Android future, it is still highly likely that users will unintentionally press and release buttons, thus causing accidental button events, such dialing a phone number or sending a text message.

Accordingly, it would be desirable to provide an improved method and system for preventing accidental triggers of button events in electronic devices.

### BRIEF SUMMARY

The exemplary embodiment provides methods and systems to preventing accidental triggers of button events in an electronic device. Aspects of exemplary environment include providing at least one affordance that is associated with a main action and is in a ready state; responsive to detecting a button event for the affordance, providing the affordance with progressive feedback related to a time the affordance is touched until the main action is invoked; and initiating the main action only after a predetermined touch hold time threshold is reached.

### BRIEF DESCRIPTION OF SEVERAL VIEWS OF THE DRAWINGS

FIG. 1 is a logical block diagram illustrating an exemplary system environment for implementing one embodiment of preventing accidental triggers of button events.

FIG. 2 is a flow diagram illustrating one embodiment of a process for preventing accidental triggers of button events.

FIG. 3A is a diagram illustrating an example user interface of a mobile device displaying a plurality of affordances/buttons.

FIGS. 3B-3E are diagrams illustrating the user interface of the mobile device after the call button has been touched and placed in a load state.

FIG. 3F is a diagram illustrating the call button in the execution state.

### DETAILED DESCRIPTION

The exemplary embodiment relates to preventing accidental triggers of button events. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems for preventing accidental triggers of button events. The exemplary embodiments provide program instructions executing on a computer that that display at least one button associated with a main action in a ready state. In response to detecting a button event for the button, progressive feedback is displayed to the user within the button related to a time the touchscreen is touched until the main action is invoked. The main action is then initiated only after a predetermined hold time threshold is reached, thus preventing accidental triggers while providing the user with intuitive feedback.

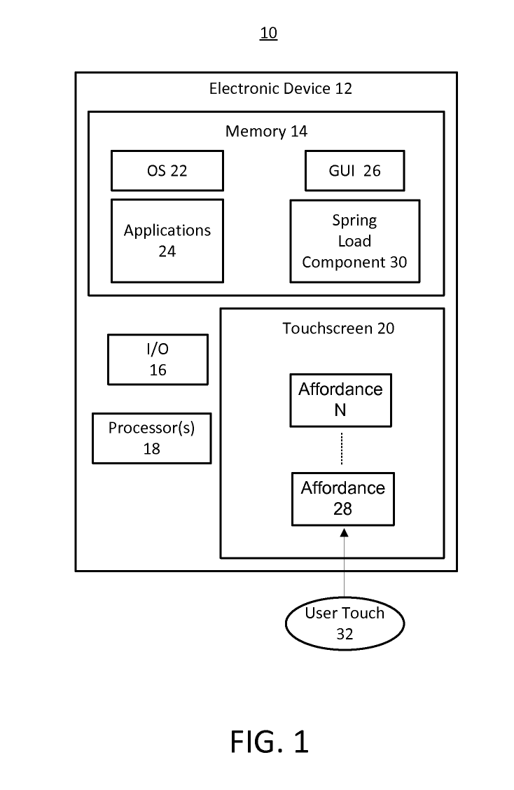

FIG. 1 is a logical block diagram illustrating an exemplary system environment 10 for implementing one embodiment of preventing accidental triggers of button events. The electronic device 12 may include a memory 14, input output (I/O) 16, at least one processor 18, and a touchscreen display (hereinafter “touchscreen”) 20. Software on the electronic device may include an operating system (OS) 22, application 24 and a graphical user interface (GUI) 26. In one embodiment, the OS 22 manages the overall operation of the electronic device 12, including managing the applications 24. The application 24 may make requests for services from the OS 22 through an application programming interface (not shown). Both OS 22 and the applications may produce the graphical user interface (GUI) 26 on the touchscreen 20.

For operation of the electronic device 12 by a user via touch input 32, the GUI 26 typically includes at least one affordance 28. As used herein, the term “affordance” means a quality of an object, or an environment, which allows a user to perform an action, and where an object's sensory characteristics intuitively imply its functionality and use. For example, a button, by being slightly raised above an otherwise flat surface or has the appearance of being raised via a shadow, suggests the idea of pushing it. In one embodiment, the GUI 26 may be controlled by soft keys displayed on the touchscreen 20 and/or with backlit hardware buttons (not shown). Once an affordance is pressed, a button event is detected and a main action associated with the affordance is typically invoked immediately, either upon a key down event, or in the case with Android, upon a key up event.

As stated above, however, there are many situations that may cause unintentionally activation of the affordance, which causes accidental button events. Unintentional phone dialing is a common action that is invoked after accidental pressing of a “call” button, for example.

According to the exemplary embodiment, the electronic device 12 is provided with a spring load component 30 that significantly reduces unintentional button events. The spring load component 30 is a software application, plugin or module that detects button events for particular affordances (e.g., a button) and provides progressive feedback within the affordance informing the user a) that the action is being spring loaded and will be executed at the end of a touch hold time while the button remains pushed state (referred to as a load state); and b) of the relative time remaining in the load state until the action is executed. After the user press and holds the affordance for the predetermined touch hold time, the main action associated with the affordance is executed. Activating the main action associated with an activated affordance only after the user press and holds the affordance for a predetermined touch hold time effectively avoids accidental pressing of the affordance. In one embodiment, the predetermined touch hold time threshold may be approximately 400 to 600 ms.

In one embodiment, the affordance is initially displayed in a ready state. Once touched, the affordance is placed in a load state. During the load state, the user must touch and hold the affordance for the touch hold time before activation of. The time remaining until activation of the action may be referred to as the loading period. When the touch hold time has been reached and/or the load time has expired, which should occur simultaneously, the affordance is placed in an execution state and the main action is executed. Thereafter, the affordance is returned to the ready state. If the affordance if lifted before the load time expires, the affordance reverts to the ready state without the main action being executed.

According to the present invention, long-pressing is used to invoke the main action associated with a button and continual feedback is provided to the user indicating when the main action will be invoked. The exemplary embodiments are best suited for applications exposed to accidental press, either because the action is exposed to unintentional press (e.g., the “emergency call” button in the Android home screen, which can be pressed accidentally as the user handles the device off-sight), or in applications where the target button is located contiguous to other affordances that are pressed repeatedly and in quick succession (e.g., keboards and keypads).

Although the spring load component 30 is shown as a single component, the functionality provided by the spring load component 30 may be implemented as more than one module or may be incorporated into one of the applications 24 or the OS 22. Thus, the above process may be performed by any combination of the spring load component 30, the OS 22, and the applications 24.

The electronic device 12 may exist in various forms, including a personal computer (PC), (e.g., desktop, laptop, or notebook), a tablet, smart phone, a set-top box, a game system, and the like. The electronic device 12 may include components of typical computing devices, including the input/output (I/O) devices 16. Examples of typical input devices may include keyboard, pointing device, microphone for voice commands, buttons, touch screen, etc., and an example of an output device is a touchscreen 20. The I/O devices team can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

A data processing system suitable for storing and/or executing program code includes one or more processors 18 coupled directly or indirectly to when one or more memory elements through a system bus. The memory 14 can include local memory employed during actual execution of the program code, bulk storage, and cache memories which provide temporary storage of at least some program code in order to reduce the number of times code must be retrieved from bulk storage during execution.

The electronic device 12 may further include a computer-readable medium, e.g., memory 14 and storage devices (e.g., flash memory, hard drive, optical disk drive, magnetic disk drive, and the like) containing computer instructions that implement the OS 22, applications 24 and an embodiment of spring load component 30 when executed by the processor(s) 18.

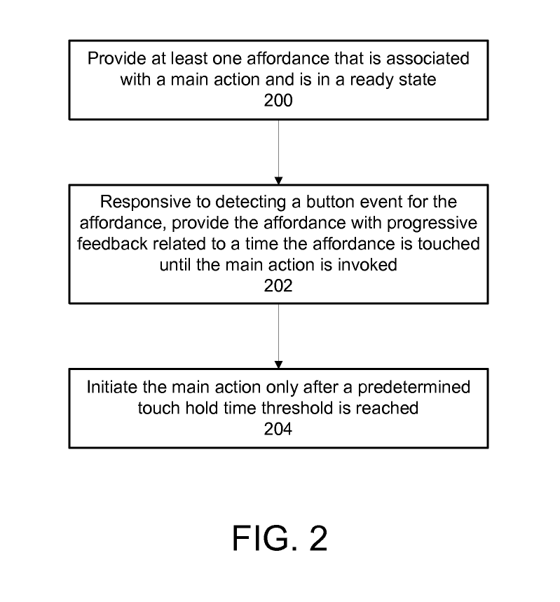

FIG. 2 is a flow diagram illustrating one embodiment of a process for preventing accidental triggers of button events. The process may begin by providing at least one affordance that is associated with a main action and is in a ready state (block 200). In one embodiment, the affordance may be a soft key displayed on the touchscreen 20. In another embodiment, the affordance may be a hardware key on a keyboard or keypad that is backlit.

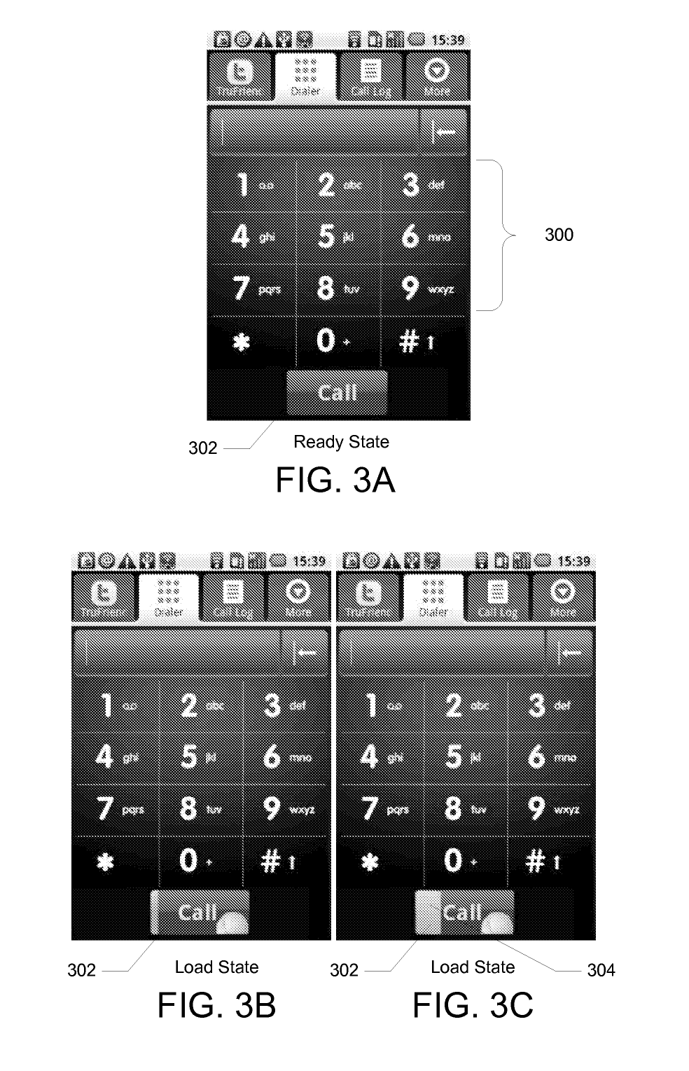

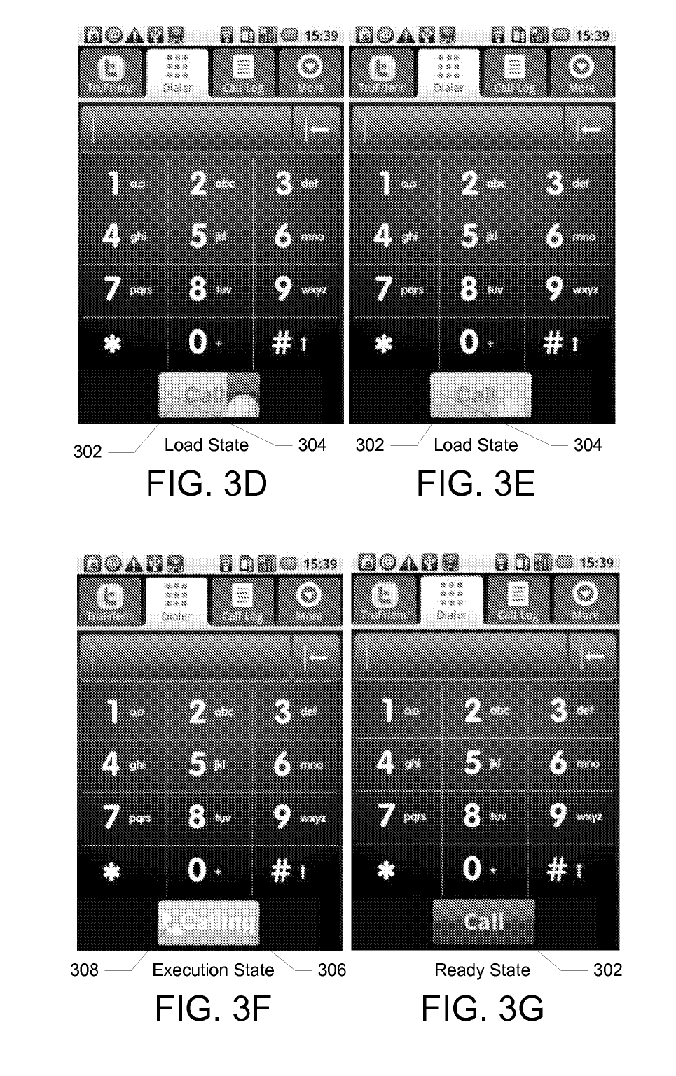

FIG. 3A is a diagram illustrating an example user interface of a mobile device displaying a plurality of affordances. In this particular example, a phone application displays a dial pad comprising soft key numbers 300 and a call button 302. The call button 302 is displayed in a ready state, which in one embodiment may mean the button is ready for activation and may be displayed with an infinitive label of the main action to be performed. In the example shown, the infinitive label is “Call,” and the main action is to call the number dialed.

Referring again to FIG. 2, responsive to the spring load component 30 detecting a button event for the affordance, the affordance is provided with progressive feedback related to a time the affordance is touched until the main action is invoked (block 202).

In one embodiment, the progressive feedback may comprise progressive audio feedback, such a beep or tone that becomes progressively louder and/or more frequent. In the exemplary embodiment, however, the progressive feedback may comprise progressive visual feedback.

FIGS. 3B-3E are diagrams illustrating the user interface of the mobile device after the call button 302 has been touched and placed in a load state. While in the load state, the button content (an area contained within boundaries of the affordance) may be changed to display progressive and continuous visual feedback. In this embodiment, the progressive visual feedback may be implemented as a progress bar 304 displayed within the call button 302. In one embodiment, the button may be provided with a progressive color filler. As described above, the progress bar may indicate a) that the main action is being spring loaded (i.e., not yet active) and will be executed at an end of a touch hold time while the affordance remains pushed state, and b) of a relative time remaining until the main action is executed, which may be referred to as the loading period.

FIG. 3E shows the progressive feedback filling the call button 302, which may represent both the touch hold time threshold being reached and/or the load time expiring, which should occur simultaneously.

Referring again to FIG. 2, after the predetermined touch hold time threshold is reached (and/or the load time expires), the main action associated with the affordance is initiated (block 204). At this time the affordance may transition to an execution state as shown in FIG. 3F.

FIG. 3F is a diagram illustrating the call button in the execution state. According to the exemplary embodiment, the progressive and continuous feedback may further include not only filling out of the affordance (button), but also changing the label from infinitive to gerund to signify the transition from the load state to the execution state. In a further embodiment, the transition from load state the execution statement also includes optionally adding/changing the iconography displayed in the button. In the example shown, the execution state changes the label 306 in the call button to “Calling,” and an optional telephone handset icon 308 is added to the button.

Thus, according to the exemplary embodiment, the label of the button may be displayed initially in the normal ready state with an infinitive verb as a label. In the load state the label may be also displayed as an infinitive verb, but with various degrees of progress feedback. In the execution state the label may change to a gerund verb plus a change in iconography.

After execution of the main action, the affordance is returned to the ready state, as shown in FIG. 3G.

A method and system for preventing accidental triggers of button events has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more non-transitory computer readable medium(s) may be utilized. The computer readable medium may be a computer readable signal medium or a computer readable storage medium. A computer readable storage medium may be, for example, but not limited to, an electronic, magnetic, optical, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for preventing accidental trigger of an action in an electronic device, the method performed by program instructions executed on a computer having at least one processor, the method comprising:
providing at least one affordance that is associated with a main action and is in a ready state;
responsive to detecting a button event for the affordance, providing the affordance with progressive feedback related to a time the affordance is touched until the main action is invoked; and
initiating the main action only after a predetermined touch hold time threshold is reached.

2. The method of claim 1 wherein the progressive feedback comprises progressive visual feedback.

3. The method of claim 2 wherein the progressive feedback is displayed within the affordance and informs a user a) that the main action is being spring loaded and will be executed at an end of a touch hold time while the affordance remains pushed state, and b) of a relative time remaining until the main action is executed.

4. The method of claim 3 wherein the progressive visual feedback comprises a progress bar.

5. The method of claim 3 wherein the progressive visual feedback comprises at least one of a change in a visual intensity of the affordance and a size of the affordance.

6. The method of claim 1 wherein the progressive feedback comprises progressive audio feedback.

7. The method of claim 1 wherein providing the at least one affordance further comprises displaying on the affordance an infinitive label of the main action to be performed.

8. The method of claim 7 wherein initiating the main action further comprises changing the label from infinitive to gerund to signify a transition from a load state to an execution state.

9. The method of claim 8 wherein signifying the transition from the load state to the execution state further comprises changing iconography displayed in the affordance.

10. The method of claim 1 wherein initiating the main action only after the predetermined touch hold time threshold is reached further comprises returning the affordance to the ready state after execution of the main action.

11. An executable software product stored on a non-transitory computer-readable medium containing program instructions for preventing accidental trigger of an action in an electronic device, the program instructions for:
providing at least one affordance that is associated with a main action and is in a ready state;
responsive to detecting a button event for the affordance, providing the affordance with progressive feedback related to a time the affordance is touched until the main action is invoked; and
initiating the main action only after a predetermined touch hold time threshold is reached.

12. The executable software product of claim 11 wherein the progressive feedback comprises progressive visual feedback.

13. The executable software product of claim 12 wherein the progressive feedback is displayed within the affordance and informs a user a) that the main action is being spring loaded and will be executed at an end of a touch hold time while the affordance remains pushed state, and b) of a relative time remaining until the main action is executed.

14. The executable software product of claim 13 wherein the progressive visual feedback comprises a progress bar.

15. The executable software product of claim 13 wherein the progressive visual feedback comprises at least one of a change in a visual intensity of the affordance and a size of the affordance.

16. The executable software product of claim 11 wherein the progressive feedback comprises progressive audio feedback.

17. The executable software product of claim 11 wherein providing the at least one affordance further comprises displaying on the affordance an infinitive label of the main action to be performed.

18. The executable software product of claim 17 wherein initiating the main action further comprises changing the label from infinitive to gerund to signify a transition from a load state to an execution state.

19. The executable software product of claim 18 wherein signifying the transition from the load state to the execution state further comprises changing iconography displayed in the affordance.

20. The executable software product of claim 11 wherein initiating the main action only after the predetermined touch hold time threshold is reached further comprises returning the affordance to the ready state after execution of the main action.

21. An electronic device, comprising:
a memory;
a user interface including at least one affordance that is associated with a main action;
at least one processor; and
at least one software component executing on the processor configured to:
responsive to detecting a button event for the affordance, provide the affordance with progressive feedback related to a time the affordance is touched until the main action is invoked; and
initiate the main action only after a predetermined touch hold time threshold is reached.

22. The electronic device of claim 21 wherein the progressive feedback comprises progressive visual feedback.

23. The electronic device of claim 22 wherein the progressive feedback is displayed within the affordance and informs a user a) that the main action is being spring loaded and will be executed at an end of a touch hold time while the affordance remains pushed state, and b) of a relative time remaining until the main action is executed.

24. The electronic device of claim 23 wherein the progressive visual feedback comprises at least one of: a progress bar, a change in a visual intensity of the affordance, and a size of the affordance.

25. The electronic device of claim 21 wherein providing the at least one affordance further comprises: displaying on the affordance an infinitive label of the main action to be performed, and wherein initiating the main action further comprises: changing the label from infinitive to gerund to signify a transition from a load state to an execution state.
